(19) United States
(12) Patent Application Publication
(10) Pub. No.: US 2006/0093706 A1
(43) Pub. Date: May 4, 2006

(54) Method for manufacturing nutritional supplement, nutritional supplement and processed grain foods using the same

(75) Inventor: Toshiya Makino, Usa-shi (JP)

Correspondence Address: SUGHRUE MION, PLLC, 2100 PENNSYLVANIA AVENUE, N.W., SUITE 800, WASHINGTON, DC, 20037, US

(73) Assignee: Toshiya MAKINO

(21) Appl. No.: 11/233,142

(22) Filed: Sep. 23, 2005

(30) Foreign Application Priority Data
Oct. 29, 2004 (JP) 2004-317251

(51) Int. Cl. A23L 1/30

(52) U.S. Cl. 426/72

(57) ABSTRACT

The present invention provides a method for manufacturing a nutritional supplement hardly generating a hygroscopic phenomenon, being hardly caked, having excellent handleability, hardly generating a browning phenomenon, capable of being stored and preserved for a long period, having excellent preservability, enhancing commercial value, capable of enhancing deliciousness, nutritional value, and nutritional balance, capable of imparting enriched flavor without sensing a fishy smell and an animal smell, and capable of effectively utilizing bony parts of fish and livestock bones which have been mostly disposed as useful food resources. The method comprises: an extraction solvent generating step of immersing an extraction material containing smoke-dried bony parts of fish and/or live stock bones in hot water, and separating an extraction residue to obtain an extraction solvent; an extraction solvent absorption step of absorbing the extraction solvent in at least one vegetable absorbent material of grains, tuberous roots, bean curd refuse, tea leaves, brans and pericarp; and a drying and powdering step of drying and powdering the vegetable absorbent material absorbing the extraction solvent.

### BACKGROUND OF THE INVENTION

1. Field of the Invention

The present invention relates to a method for manufacturing a nutritional supplement using bony parts of fish and livestock bones, the nutritional supplement and a processed grain foods using the same.

1. Description of the Prior Art

Nutritional additives and food with which minerals and vitamins have been blended have been conventionally developed by using disposed food resources and small fishes or the like such as bones of fish, pig bones, cow bones and chicken bones. The various nutritional supplements with which vitamins and minerals have been blended with sufficient balance for the purpose of antiaging or health promotion have also been developed.

As a prior art using the fish bones, pig bones, cow bones, and chicken bones, for example, a [Patent Reference 1] discloses a “nutritional additive obtained by boiling some kinds of vegetables, fish bones, pig bones, cow bones and chicken bones or the like in hot water, refining the stock to produce a soft and granular extract.” A [Patent Reference 2] discloses a “nutritionally balanced food in which the respective powder particles of tea leaves, small fishes and seaweeds have been blended at a predetermined rate”.

[Patent Reference 1]
Japanese Published Unexamined Patent Application No. H6-217734

[Patent Reference 2]
Japanese Published Unexamined Patent Application No. 2001-309762

However, the above prior arts had the following problems.

(1) In the art disclosed in the [Patent Reference 1], soft and granular animal extract produced by refining the stock of fish bones and pig bones or the like has remarkable hygroscopic property. In addition, once the animal extract absorbs moisture, an adhesive property is rapidly generated. Then, the animal extract is softened and caked, and thereby the handleability is lacking. Particularly, the animal extract is easily caked under a highly humid condition, and thereby the commercial value is remarkably diminished.

(2) When the fish bones, pig bones, cow bones and chicken bones or the like are boiled in hot water, the deliciousness of fish and meat is extracted, and the fishy smell of the fish and the animal smell of beasts and birds may be sensed. Therefore, the obtained soft and granular animal extract may emit a peculiar smell.

(3) When the extraction solvent extracted from the fish bones is condensed, amino acids and sugars as the main body of delicious tasting ingredients bind together, and a browning phenomenon worsening the taste is easily generated. Therefore, the quality is easily deteriorated within a short period of time.

(4) Since the art disclosed in the [Patent Reference 2] uses small fishes capable of being easily pulverized, particulates produced in a simple grinding machine such as a mixer can be utilized as nutritionally balanced food. However, fish bones, pig bones, cow bones and chicken bones or the like are too firm to be easily pulverized. Thereby, though they were useful food resources, they could not be fully utilized.

The present invention solves the above conventional problems, and it is an object of the present invention to provide a method for manufacturing a nutritional supplement hardly generating a hygroscopic phenomenon, being hardly caked, having excellent handleability, hardly generating a browning phenomenon, capable of being stored and preserved for a long period, having excellent preservability, enhancing commercial value, capable of enhancing deliciousness, nutritional value, and nutritional balance, capable of imparting an enriched flavor without sensing a fishy smell and an animal smell, and capable of effectively utilizing bony parts of fish and livestock bones which have been mostly disposed as useful food resources. It is another object of the present invention to provide a nutritional supplement having excellent deliciousness, nutritional value and nutritional balance, capable of being stored and preserved for a long period, having excellent preservability, excellent in applicability since the vegetable absorbent material can be mixed with other food material such as flour or the like, and the nutritional supplement is formed into pellets or the like to be processed into tablets, hardly generating a hygroscopic phenomenon, being hardly caked, having excellent handleability, hardly generating a browning phenomenon, enhancing commercial value, having an enriched flavor without sensing a fishy smell and an animal smell, and capable of effectively utilizing bony parts of fish and livestock bones which have been mostly disposed as useful food resources. It is another object of the present invention to provide processed grain foods having nutrients and minerals such as collagen, mucopolysaccharides, amino acids, calcium, iron and zinc or the like, and plant proteins, carbohydrates, minerals and vitamins, and having high nutritional value.

### SUMMARY OF THE INVENTION

So as to solve the above conventional problems, a method for manufacturing a nutritional supplement of the present invention, the nutritional supplement and processed grain foods using the same have the following composition.

A method for manufacturing a nutritional supplement according to the first aspect of the present invention, comprising: an extraction solvent generating step of immersing an extraction material containing smoke-dried bony parts of fish and/or livestock bones in hot water, and separating an extraction residue to obtain an extraction solvent; an extraction solvent absorption step of absorbing the extraction solvent in at least one vegetable absorbent material of grains, tuberous roots, bean curd refuse, tea leaves, brans and pericarp; and a drying and powdering step of drying and powdering the vegetable absorbent material absorbing the extraction solvent.

The following effects are obtained by the composition.

(1) In the extraction solvent generating step, delicious tasting ingredients containing minerals such as collagen, mucopolysaccharides, amino acids, calcium, iron and zinc or the like are dissolved into the hot water from a bone medullary substance, and are extracted. Since the vegetable absorbent material such as grains and bean curd refuse absorbs the extraction solvent in which the delicious tasting ingredients are dissolved into the extraction solvent absorption step, the deliciousness, nutritional value and nutritional balance of the vegetable absorbent material can be enhanced.

(2) Since the drying and powdering step is provided, the vegetable absorbent material such as tea leaves and tuberous roots can be powdered to be easily eaten. Also, since moisture is removed, the nutritional supplement can be stored and preserved for a long period, and has excellent preservability. Furthermore, since the nutritional supplement is mixed with other food material such as flour, and the vegetable absorbent material is formed into pellets or the like to be processed into tablets, the vegetable absorbent material excels in applicability.

(3) Since an animal extraction solvent is absorbed in the vegetable absorbent material, and the vegetable absorbent material is dried and powdered, the animal extraction solvent is dispersed in the vegetable absorbent material. Thereby, a hygroscopic phenomenon observed when the animal extraction solvent itself is dried and is shaped into a granular shape is hardly generated, and the animal extraction solvent is hardly caked. The animal extraction solvent has excellent handleability, hardly generates a browning phenomenon, and can enhance commercial value.

(4) Since the smoke-dried bony parts of fish and livestock bones are used, a fishy smell and animal smell can be hardly sensed, and the enriched flavor due to smoke-drying can be imparted.

(5) Since the bony parts of fish and livestock bones which have been mostly disposed are used, and the delicious tasting ingredients are extracted from the bony parts of fish and livestock bones, the bony parts of fish and livestock bones can be effectively utilized as useful food resources at low cost.

Herein, a head, scales and midribs or the like left after cutting the fish and removing the flesh are used as the bony parts of fish for the extraction material, and the bony parts of fish are produced as residual when minced fish which mainly serves as a raw material for fish-paste products is manufactured. Though sardine, cod, Walleye Pollack, sea bass, colin, blue grenadier and salmon or the like can be used as the fish for the extraction material, the fish is not limited thereto.

Since much fish flesh with much fat is adhered to the midribs of the bony parts of the fish, taste components can be increased by using with the fish flesh adhered.

Bones other than head and leg parts produced when producing chickens such as chicken meat and ostrich meat or the like are used as the livestock bones of the extraction material, and for example, chicken bone as a part in which a backbone and a rib bone are united from a neck bone, thigh and small bones of a leg or the like are used. Bones such as thighbones, upper forelimb bones and rib bones produced when meat is produced from livestock such as a cow, a horse, a pig and a sheep can be used. Though the meat may not be adhered to the livestock bones, the meat is preferably adhered to some degree. It is because the taste component can be thereby increased to increase appetite.

It is preferable to perform a blood-letting and washing step of removing and washing the blood of the bony parts of the fish and livestock bones of the extraction material in advance. This is so a bitter flavor and blood smell or the like cannot be sensed. The blood-letting and washing step is particularly effective when the chicken bones and the bony parts of fish to which filth, mud and blood or the like are adhered are used. The blood-letting and washing are performed by immersing in a diluted water solution such as water, hot water, sodium hypochlorite and chlorine dioxide for 5 to 30 minutes. In the case of frozen bones, the washing can be performed while defrosting and performing blood-letting in a solution such as diluted sodium hypochlorite and chlorine dioxide.

It is preferable that large livestock bones such as pig bones and cow bones or the like are smoke-dried after cracking in part as they are, or cutting into a length of about 2 to about 3 cm. After being smoke-dried, the livestock bones can be cut into a size of about 2 to about 3 cm, and also be immersed in hot water. Small livestock bones such as chicken bones or the like can be cut into a size of about 3 mm to about 3 cm, or can be pulverized to be processed before and after being smoke-dried. This is because the methods enhance the extraction efficiency when obtaining the extraction solvent.

For smoking and drying, a method for adhering smoke generated by burning or smoking a smoking material such as wood to the bony parts of fish and livestock bones is used. Pretreatments such as preserving with salt and various seasoning preserving or the like can also be performed. Since ingredients such as tar in smoke are adhered to the surface of the bony parts of fish and livestock bones and apart thereof is permeated, a unique flavor is obtained, and the taste components are increased. In addition, the generation of bacteria is suppressed, and a bactericidal action is provided. Furthermore, the oxidization of oil and fats can be prevented, and the deterioration in quality can be prevented to provide storage quality.

One or multiple kinds of various woods such as Japanese oak, white oak, maple, sawtooth oak, cedar and cherry, tea leaves such as green tea leaves, and pericarp of fruits such as citrus fruits and grapes can be used as the smoking material. When the tea leaves (used tea leaves) used as food waste after decocting tea are used as the smoking material, the effective use of the food waste can be preferably attained. The pericarp is also preferable since the food waste can be effectively used.

The extraction material is preferably smoke-dried so that the surface temperature of the extraction material is set to 60 to 120° C. This is because the extraction solvent hardly tends to have a smoking-characteristic flavor as the surface temperature becomes lower than 60° C., the extraction solvent tends to have a bitter flavor and irritating taste as the surface temperature becomes higher than 120° C., thereby the deliciousness is reduced in both temperature regions.

In the extraction solvent generating step, the weight of the hot water is 4 to 10 times the weight of the extraction material as the weight rate of the extraction material such as the livestock bones and hot water, and preferably 5 to 8 times. The extraction efficiency of the deliciousness of the extraction material into the hot water tends to be reduced as the weight of the hot water becomes less than 5 times. The deliciousness tends to be hardly sensed fully as the weight of the hot water becomes more than 8 times. Particularly, when the weight of the hot water become less than 4 times or more than 10 times, these tendencies become remarkable, and thereby neither is preferable.

Referring to the temperature of the hot water and the immersion time of the extraction material in the extraction solvent generating step, the temperature is 80 to 100° C., and the heating time is 1 to 10 hours. The temperature is preferably 90 to 95° C., and the heating time is suitably 1.5 to 4 hours. The delicious tasting ingredients contained in the extraction material tend not to be able to be fully extracted in the hot water as the temperature of the hot water becomes lower than 90° C. or the heating time becomes shorter than 1.5 hours. The richness tends to be lost from the flavor of the extraction solvent and the depth tends to become poor as the temperature of the hot water becomes higher than 95° C. or the heating time becomes longer than 4 hours. When the temperature of the hot water becomes lower than 80° C. in particular, or the heating time becomes shorter than 1 hour or longer than 10 hours, these tendencies are remarkable, and thereby neither is preferable.

When the extraction material contains the bony parts of the fish, referring to the temperature of the hot water and the immersion time of the extraction material in the extraction solvent generating step, the temperature is 70 to 100° C., and the heating time is 0.2 to 1 hour. It is preferable that the temperature is 80 to 95° C. and the heating time is 0.3 to 0.5 hours. The delicious tasting ingredients contained in the extraction material tend not to be able to be fully extracted in the hot water as the temperature of the hot water becomes lower than 80° C. or the immersion time becomes shorter than 0.3 hours. The extracted fish oil is easily oxidized as the temperature of the hot water becomes higher than 95° C. or the heating time becomes longer than 0.5 hours. The unpleasant smell thereby tends to be emitted with the oxidization of the fish oil, and the taste components and fragrance of the extraction solvent tend to be lost. When the temperature of the hot water becomes lower than 70° C. in particular, or the heating time becomes shorter than 0.2 hours or longer than 1 hour, these tendencies are remarkable, and thereby neither is preferable.

In the extraction solvent generating step, the extraction material and water can be put into a pressure cooker, and the extraction solvent can also be generated by the hot water under a high temperature and high pressure. Thereby, the extraction solvent can be obtained in a short time, and the productivity can be enhanced. Referring to the conditions in this case, the pressure of 120 to 210 kPa and the temperature of 105 to 120° C. are suitably used. The extraction time tends to be hardly shortened as the pressure becomes lower than 120 kPa and the temperature becomes lower than 105° C. A strong pressurized container or the like is required, energy-saving performance is insufficient as the pressure becomes higher than 210 kPa and the temperature becomes higher than 120° C. Thereby, neither is preferable.

Salts, salts of inosinic acid, glutamate and capsicum or the like can also be put into the hot water. Thereby, the deliciousness of the extraction solvent can be suitably increased.

After the extraction material is immersed in the hot water, an extraction residue is separated, and the extraction solvent is obtained. Lixivium floating on the hot water can also be scooped. The extraction residue can be separated and removed by filtration processing and centrifugal separation processing or the like.

When the extraction material contains the bony parts of the fish, fish oil in the extraction solvent is preferably separated and removed by the centrifugal separation or the like. This is because the oxidization can be prevented by reducing the content of fish oil in the extraction solvent, and the delicious tasting ingredients and fragrance are kept for a long period to enhance storage quality.

Rice, wheat, barley, rye, adlay, buckwheat, oat, millet, sawa millet, foxtail millet and corn or the like are used as the grains of the vegetable absorbent material used in the extraction solvent absorption step. Plant proteins, carbohydrates, minerals and vitamins (B group and E or the like) can be added by using the grains, and the nutritional balance can be adjusted.

Potato, sweet potato and aroid or the like are used as the tuberous roots of the vegetable absorbent material. This is because carbohydrates, potassium and vitamin C or the like are abundantly included therein.

The nutritional balance can be adjusted by carbohydrates and plant proteins using the bean curd refuse as the vegetable absorbent material, and illnesses such as corpulence, diabetes and high blood pressure or the like can be expectably prevented by the dietary fiber contained in the bean curd refuse. The use expansion of the bean curd refuse strained lees of soy milk at the time of tofu manufacture, generated in large quantities, seldom utilized and mostly disposed can be attained, and waste can be effectively used.

Tea leaves for fermented teas such as red tea, tea leaves for half-fermented teas such as oolong tea and pouchong tea, tea leaves for post-fermented teas such as pu-ehr tea and tea leaves for unfermented teas such as green tea or the like are used as the tea leaves of the vegetable absorbent material. Minerals, potassium, and vitamins (A.B group, E or the like) can be added by using the tea leaves. When the tea leaves as food waste after decocting tea are used, the effective use of the food waste can be preferably attained.

As the bran of the vegetable absorbent material, an outer cover removed by grain cleaning and milling or the like of grains such as rice bran, wheat bran and oat bran issued. Particularly, the rice bran is suitably used. This is because a large amount of rice bran is generated when brown rice is cleaned, and the rice bran includes a large amount of protein, minerals and vitamin B group or the like, and has high nutritional value. Roasted rice bran is preferably used. This is because a unique deliciousness and aroma are formed by a heat reaction from the protein, fat and carbohydrates or the like in the rice bran, and the deliciousness can be increased.

One or multiple kinds of pericarp of citrus fruits such as mandarin oranges and kabosu, and grapes or the like are used as the pericarp of the vegetable absorbent material. Thereby, the aroma can be imparted, and vitamin C or the like contained in the pericarp of citrus fruits and polyphenol or the like contained in the pericarp of the grapes can be added. Thereby, nutritional value can be enhanced. The pericarp as food waste generated in large quantities in a food factory or the like can be effectively used, and are excellent in resource saving. After the pericarp is dried, it is preferable to pulverize the dried pericarp and add the powdered pericarp. This is because the extraction solvent is absorbed therein and is uniformly dispersed.

A raw absorber, a material suitably cut, a pulverized material, a dried material, a heated material and a frozen material or the like can be used for the above vegetable absorbent material. Particularly, the vegetable absorbent material of which the moisture content is dried to about 5 to about 60% is suitably used. This is because the vegetable absorbent material excels in productivity since the absorption efficiency thereof is high, and the flavor of the extraction solvent can be prevented from vaporizing and deteriorating in the extraction solvent absorption step.

When the vegetable absorbent material contains a large amount of oil, it is preferable to use the vegetable absorbent material after the part thereof is preliminarily removed or degreased. This is because the absorption of the extraction solvent is thereby promoted.

In the extraction solvent absorption step, a method for boiling vegetable absorbent material in the extraction solvent under an atmospheric pressure condition or using a pressure cooker or the like, and a method for contacting the extraction solvent with the vegetable absorbent material set under a decompression condition or the like are used as a method for absorbing the extraction solvent to the vegetable absorbent material. Particularly, the method for boiling the vegetable absorbent material under the atmospheric pressure condition or using the pressure cooker or the like in the extraction solvent is suitably used. This is because the vegetable absorbent material can be softened by heating, and the vegetable absorbent material can be atomized in the drying and powdering step.

In the drying and powdering step, the vegetable absorbent material absorbing the extraction solvent is compressed and pulverized if necessary. After the vegetable absorbent material is slurried in a state where the extraction solvent exists, the vegetable absorbent material is dried by spray drying, vacuum drum drying, freeze drying and hot air drying or the like. When the vegetable absorbent material is slurried, moisture can be removed by spray drying, vacuum drum drying and freeze drying or the like, and can be powdered. The vegetable absorbent material can also be granulated by suitably selecting the drying condition.

When the vegetable absorbent material is not slurried, the vegetable absorbent material can be pulverized and miniaturized by using a pulverizer usually used throughout the food industry such as a chopper, a cutter and a shock type pulverizer in a state where the extraction solvent exists after the vegetable absorbent material is dried or a state where the extraction solvent before being dried exists. In this case, for example, the size of the pulverized vegetable absorbent material is 500 μm or less, and preferably 300 μm or less. This is because a foreign-body sensation is not sensed when eating, and texture and feeling on the tongue or the like are smoothened.

The water activity of the vegetable absorbent material dried and powdered by the drying and powdering step is 0.2 to 0.6, and preferably 0.3 to 0.5. The vegetable absorbent material tends to lack the deliciousness as the water activity becomes less than 0.3. Molds or the like are easily generated as the water activity is more than 0.5, and the preservability tends to be reduced. When the water activity becomes in particular less than 0.2, or becomes more than 0.6, these tendencies are remarkable, and thereby neither is preferable.

According to a second aspect of the present invention, there is provided a method for manufacturing a nutritional supplement as set forth in the first aspect of the present invention, wherein the extraction material contains at least one of vegetables, pericarp and seaweeds. The following effects are obtained by the composition in addition to the effect obtained in the first aspect.

(1) Since the extraction material contains at least one of the vegetables, pericarp and seaweeds, the flavor of the vegetables, pericarp and seaweeds is added to the extraction solvent, sweet taste is increased, and the deliciousness of the extraction solvent deepens. Furthermore, the fishy smell and animal smell can be reduced.

Herein, though cabbages, Brussels sprouts, onions, carrots, turnips, celeries, Japanese radishes, cauliflower, green peas, garlic, corns, shallots, parsleys, broccolis, Welsh onions, Chinese cabbage, tomatoes, pumpkins, Chinese mushrooms, Flammulina veluptipes and mushrooms or the like can be used as the vegetables, the vegetables are not limited thereto. Herbs such as thyme and bay leaves or the like can also be added. Citrus fruits such as oranges and kabosu or the like, and fruits such as grapes or the like are used as the fruits of which the pericarp is contained in the extraction material.

Though wakame seaweed, sea tangle, hijiki or the like are used as the seaweeds, the seaweeds are not limited thereto.

The amount of the bony parts of fish and/or livestock bones to the whole amount of the extraction material is 10 to 60% by weight when adding at least one of the vegetables, pericarp and seaweeds to the extraction material, and preferably 35 to 55% by weight. Thereby, the extraction solvent having a deep richness and improved balance can be obtained.

As the amount of the bony parts of fish and/or livestock bones to the whole amount of the extraction material becomes less than 35% by weight, the deliciousness of fish or meat is reduced. Also, the grassy smell and astringency of vegetables tend to be strengthened based on the kinds of vegetables or the like. As the amount becomes more than 55% by weight, the sweet taste of the vegetables or the like is reduced, and the richness tends to be reduced. When the amount becomes less than 10% by weight in particular, or becomes more than 60% by weight, these tendencies are remarkable, and thereby neither is preferable.

According to a third aspect of the present invention, a nutritional supplement contains a vegetable absorbent material containing at least one of dried and powdered grains, bean curd refuse, tea leaves, brans and tuberous roots absorbing an extraction solvent of smoke-dried bony parts of fish and/or livestock bones.

The following effects are obtained by the composition.

(1) Since the vegetable absorbent material such as dried and powdered grains absorb the extraction solvent containing the minerals such as collagen, mucopolysaccharides, amino acids, calcium, iron and zinc or the like dissolved out from the livestock bones or the like, the vegetable absorbent material excels in deliciousness, nutritional value and nutritional balance.

(2) Since the vegetable absorbent material such as tea leaves and tuberous roots is powdered, the vegetable absorbent material can be easily eaten. Also, since the vegetable absorbent material is dried, the vegetable absorbent material can be stored and preserved for a long period and has excellent preservability. Furthermore, the vegetable absorbent material excels in applicability since the vegetable absorbent material can be mixed with other food material such as flour or the like, and the vegetable absorbent material is formed into pellets or the like to be processed into tablets.

(3) The animal extraction solvent is absorbed in the vegetable absorbent material, and the vegetable absorbent material is dried and powdered. Also, the animal extraction solvent is dispersed in the vegetable absorbent material. Thereby, the vegetable absorbent material hardly generates a hygroscopic phenomenon, is hardly caked, has excellent handleability, hardly generates a browning phenomenon and enhances commercial value.

(4) Since the smoke-dried bony parts of fish and livestock bones are used, the fishy smell and the animal smell can be hardly sensed, and the enriched flavor due to smoke-drying can be imparted.

(5) Since the bony parts and backbones of fish which have been mostly disposed are used, and the delicious tasting ingredients are extracted from the bony parts of fish and livestock bones, the bony parts of fish and livestock bones can be effectively utilized as useful food resources at low cost.

Herein, since smoke drying, the bony parts of fish, livestock bones, the vegetable absorbent material and the extraction solvent are the same as those explained in the first aspect, the explanations thereof are omitted.

According to a fourth aspect of the present invention, there is provided a nutritional supplement as set forth in the third aspect of the present invention, wherein the extraction solvent of at least one of vegetables, pericarp and seaweeds is absorbed in the vegetable absorbent material.

The following effects are obtained by the composition in addition to the operation obtained in the third aspect.

(1) Since the extraction solven to fat least one of the vegetables, pericarp and seaweeds is absorbed in the vegetable absorbent material, the flavor of the vegetables, pericarp and seaweeds is added, the sweet taste is increased, and the deliciousness of the extraction solvent deepens. Furthermore, the fishy smell and animal smell can be reduced.

Herein, since the vegetables, the pericarp and the seaweeds are the same as those explained in the second aspect, the explanations thereof are omitted.

The extraction solvent of Chinese medicines can also be absorbed in the vegetable absorbent material. Thereby, the medicinal benefits due to Chinese medicines can be obtained. Examples of Chinese medicines include liquorice root, ginger, medicinal carrot, ephedra herba, rhubarb and turmeric or the like. These can be suitably selected.

According to a fifth aspect of the present invention, there is provided a nutritional supplement as set forth in the third or fourth aspect of the present invention, wherein at least one of health foods, enrichments, fungi, sweeteners and vinegars is mixed in the dried and powdered vegetable absorbent material.

The following effects are obtained by the composition in addition to the effects obtained in the third aspect and fourth aspect.

(1) When health foods, enrichments and vinegars are mixed with the dried and powdered vegetable absorbent material, the vegetable absorbent material can compensate insufficient nutrients and functions using the enrichments or the like, and the nutritional supplement which is excellent in nutritional balance, prevention of lifestyle-related diseases and antiaging, and excellent as dietary foods can be obtained.

(2) Since ingredients of nutrients or the like having a high concentration of health foods and enrichments are diluted by the vegetable absorbent material, health disorders due to superfluous ingestion of health foods or the like can be prevented, and the load given to digestive organs such as the stomach can be reduced. This is because a health disorder due to superfluous ingestion may be caused since health foods and enrichments contain ingredients of nutrients or the like, having a higher concentration than that of usual foods. And it is because a load is applied to the digestive organs such as the stomach, or a great deal of nutrients which cannot be absorbed are generated, and are discharged from the body when the nutrients having a high-concentration enter into the body at once, and thereby the expected effect cannot be obtained even if the health foods and enrichments are ingested, and health may be affected.

(3) When the vegetable absorbent material is mixed with sweeteners, palatability or the like can be enhanced. When the fungi are mixed, infection defense ability and immune ability or the like can be enhanced.

Herein, though chlorella, soft-shelled turtle processed food, prune extract processed food, vitamin C-containing food and royal jelly or the like are used as health foods, health foods are not limited thereto.

Food additives or the like added so as to compensate nutrients such amino acids, vitamins and minerals or the like can be used as the enrichments. Examples thereof include collagen, polyphenol, carnitine, vitamin K, chitosan, onion powder, Caiapo potato and guava tea or the like.

Indigenous intestinal bacteria and monascus pilosus such as lactobacillus, bifidobacteria and enterococci or the like are used as the fungi.

Oligosaccharide, momordicae fructus and muscovado or the like are used as the sweeteners.

For example, grain vinegar manufactured by using grains such as rice, wheat, sake lees and corn or the like as main raw materials, and fruit vinegar or the like manufactured by using fruits such as apples, grapes and citrus fruits as main raw materials can be used as the vinegar.

The content of the health foods and enrichments or the like to the vegetable absorbent material can be suitably selected according to insufficient nutrients and purpose.

According to a sixth aspect of the present invention, processed grain foods containing the nutritional supplement as set forth in any one of the third aspect to the fifth aspect is provided.

The following operations are obtained by the composition.

(1) Since the nutritional supplement is contained, nutrients and minerals such as collagen, mucopolysaccharides, amino acids, calcium, iron and zinc or the like extracted from livestock bones or the like, plant proteins of grains and tuberous roots, carbohydrates, minerals and vitamins are imparted, and the nutritional value can be enhanced, and palatability can be enhanced.

(2) The variation of foods can be increased, and even if processed grain foods are usually eaten, the processed grain foods can hardly become tiring.

(3) Since the processed grain foods can be used as a principal food, and the nutritional supplement consists of various foods, various foods can be taken in only by eating one kind of processed grain foods.

Herein, as the processed grain foods, foods manufactured by using grains such as wheat and rice or the like as the main materials, and by processing such as molding, drying and heating or the like are used. Examples thereof include noodles such as Japanese wheat noodles, slender wheat noodles, silver wheat noodles, Chinese noodles, macaroni, noodles and pastas, confectioneries such as cookies, biscuits, sponge cakes, cakes, rice crackers, sliced and dried rice cakes, cubic rice crackers and buns, and breads or the like obtained by processing using grains such as flour and rice flour as main materials. However, the processed grain foods are not limited thereto.

These processed grain foods can be manufactured by mixing the grains such as flour and rice or the like, and a proper amount of nutritional supplement and water, kneading the dough and forming the dough in a predetermined shape. The processed grain foods can be extruded to grains and sticks or the like by using an extruder, and can also be expanded. The processed grain foods can also be manufactured by means of putting the dough into a mold and baking the dough, forming the dough, drying the dough and baking the dough, and forming the dough and steaming the dough or the like. The smoke-drying processing described in the first aspect to one processed can also be performed. In addition, when the smoke-drying processing is performed, a confitted sauce containing soy sauce, vinegar and oil or the like can also be applied. Thereby, palatability and preservability can be enhanced.

The amount of mixture of the grains and nutritional supplement can be suitably selected according to the use of the food.

As described above, according to the method for manufacturing the nutritional supplement of the present invention, the nutritional supplement and the processed grain foods using the same, the following advantageous effects can be obtained.

(1) The first aspect of the present invention can provide the method for manufacturing the nutritional supplement capable of enhancing the deliciousness, nutritional value and nutritional balance of the vegetable absorbent material since delicious tasting ingredients containing minerals such as collagen, mucopolysaccharides, amino acids, calcium, iron and zinc are dissolved out into the hot water from a bone medullary substance and is extracted to generate the extraction solvent, and the vegetable absorbent material such as the grains and the bean curd refuse or the like absorbs the extraction solvent in which the delicious tasting ingredients are dissolved.

(2) The present invention can provide the method for manufacturing the nutritional supplement in which the vegetable absorbent material can easily be eaten by powdering the vegetable absorbent material such as tea leaves and tuberous roots or the like, in which the vegetable absorbent material cane stored and preserved for a long period since moisture is removed, which has excellent preservability, and which can excel in applicability since the vegetable absorbent material is mixed with other food material such as flour, and the vegetable absorbent material is formed into pellets or the like to be processed into tablets.

(3) The present invention can provide the method for manufacturing the nutritional supplement hardly generating a hygroscopic phenomenon observed when the animal extraction solvent itself is dried and is shaped into a granular shape, hardly caking the animal extraction solvent, having excellent handleability, hardly generating browning phenomenon, and capable of enhancing commercial value since the animal extraction solvent is dispersed in the vegetable absorbent material.

(4) The present invention can provide the method for manufacturing the nutritional supplement capable of eliminating the fishy smell and the animal smell, and imparting an enriched flavor due to smoke-drying.

(5) The present invention can provide the method for manufacturing the nutritional supplement capable of effectively utilizing the bony parts of fish and livestock bones which have been mostly disposed as useful food resources at low cost.

The second aspect of the present invention can provide (1) the method for manufacturing the nutritional supplement to which the flavor of vegetables, pericarp and seaweeds is added, increasing the sweet taste, having deeper deliciousness, and reducing the fishy smell and animal smell in addition to the effects of the first aspect.

(1) The third aspect of the present invention can provide the nutritional supplement excelling in deliciousness, nutritional value and nutritional balance since the vegetable absorbent material such as the dried and powdered grains absorbs the extraction solvent containing the minerals such as collagen, mucopolysaccharides, amino acids, calcium, iron and zinc or the like dissolved out from livestock bones or the like.

(2) The present invention can provide the nutritional supplement capable of being easily eaten since the vegetable absorbent material such as tea leaves and tuberous roots or the like is powdered, capable of being stored and preserved for a long period and has excellent preservability since the vegetable absorbent material is dried, and excellent in applicability since the vegetable absorbent material is mixed with other food material such as the flour or the like, and the vegetable absorbent material is formed into pellets or the like to be processed into tablets.

(3) The present invention can provide the nutritional supplement hardly generating a hygroscopic phenomenon, being hardly caked, having excellent handleability, hardly generating a browning phenomenon and enhancing commercial value.

(4) The present invention can provide the nutritional supplement capable of hardly sensing the fishy smell and the animal smell, and imparting an enriched flavor due to smoke-drying since the smoke-dried bony parts of the fish and livestock bones are used.

(5) The present invention can provide the nutritional supplement capable of effectively utilizing the bony parts of fish and livestock bones which have been mostly disposed as useful food resources at low cost.

The fourth aspect of the present invention can provide (1) the nutritional supplement to which the flavor of vegetables and pericarp is added, increasing the sweet taste, deepening deliciousness, reducing the fishy smell and animal smell in addition to the third aspect.

(1) The fifth aspect of the present invention can provide the nutritional supplement capable of compensating insufficient nutrients and functions using the enrichments or the like, and the nutritional supplement excelling in nutritional balance, prevention of lifestyle-related diseases and antiaging, and excelling as dietary foods when health foods, enrichments and vinegars are mixed with the vegetable absorbent material dried and powdered in addition to the effects of the third aspect or fourth aspect.

(2) The present invention can provide the nutritional supplement capable of preventing health disorders due to superfluous ingestion of health foods or the like, and reducing the load given to the digestive organs such as the stomach.

(3) The present invention can provide the nutritional supplement capable of enhancing palatability, the infection defense ability and the immune ability or the like.

(1) The sixth aspect of the present invention can provide processed grain foods capable of providing nutrients and minerals such as collagen, mucopolysaccharides, amino acids, calcium, iron and zinc extracted from the livestock bones or the like, plant proteins of grains and tuberous roots, carbohydrates, minerals and vitamins, and enhancing the nutritional value and the palatability.

(2) The present invention can provide processed grain foods capable of increasing the variation of foods, and the processed grain foods hardly become tiring even if the processed grain foods are usually eaten.

(3) The present invention can provide the processed grain foods capable of taking in various foods only by eating one kind of processed grain foods since the processed grain foods can be used as a principal food, and the nutritional supplement consists of various foods.

### DESCRIPTION OF THE PREFERRED EMBODIMENTS

Hereinafter, the present invention will be specifically described by way of examples. The present invention is not limited thereto.

### EXAMPLE 1

Cow ribs of 100 weight parts as the livestock bones cut to 2 cm in width were put on a rack in a smoking apparatus, and Japanese oak material was used as the smoking material. The livestock bones were smoked for 1 hour while the temperature in the smoking apparatus (the same as the temperature of the surface of the livestock bones) was set to 90° C.

The smoke-dried livestock bones were put in a pan containing water of 500 weight parts, and the water was heated. The livestock bones were immersed in hot water of 90° C. for 3 hours. After lixivium was fully scooped, the hot water was filtered, and extraction residue of the livestock bones was separated and removed to obtain an extraction solvent (extraction solvent generating step).

Peeled and cut potato of 50 weight parts and milled rice (rinsed) of 100 weight parts as the vegetable absorbent material were added into the obtained extraction solvent, and thoroughly boiled. The extraction solvent was absorbed to the vegetable absorbent material (extraction solvent absorption step). When the potato and rice of the vegetable absorbent material were softened while being continuously heated, these were pulverized, and the extraction solvent was slurried.

The slurry-like extraction solvent was spray dried (drying and powdering step) to obtain a nutritional supplement of Example 1.

### EXAMPLE 2

The bony parts of 100 weight parts of sea bass as the bony parts of fish were washed with water to drain blood (blood-letting and washing step). Next, the bony parts were put on a rack in the smoking apparatus, and Japanese oak material was used as the smoking material. The bony parts of the fish were smoked for 2 hours while the temperature in the smoking apparatus (the same as the temperature of the surface of the livestock bones) was set to 70° C., and the bony parts of the fish were smoke-dried.

The smoke-dried bony parts of the fish and Welsh onion of 2 weight parts were put in a pan containing water of 400 weight parts, and the water was heated. The bony parts of the fish were immersed in the hot water of 80° C. for 0.5 hours. After lixivium was fully scooped, the hot water was filtered, and the extraction residue of the Welsh onion and bony parts of the fish were separated and removed to obtain an extraction solvent (extraction solvent generating step).

Barley (cornmeal) of 100 weight parts and bean curd refuse of 50 weight parts as the vegetable absorbent material were added into the obtained extraction solvent, and thoroughly boiled. The extraction solvent was absorbed to the vegetable absorbent material (extraction solvent absorption step).

The vegetable absorbent material absorbing the extraction solvent was dried at 80 to 90° C. in a hot air dryer for 12 hours to obtain a dried matter. This dried matter was pulverized and powdered by a pulverizer (drying and powdering step) to obtain a nutritional supplement of Example 2.

### EXAMPLE 3

Chicken bones of 100 weight parts as the livestock bones cut to 3 cm in width are fully washed with water to drain blood (blood-letting and washing step). Next, the chicken bones were put on a rack in the smoking apparatus, and cherry material was used as the smoking material. The livestock bones were smoked and dried for 1 hour while the temperature in the smoking apparatus (the same as the temperature of the surface of the livestock bones) was set to 100° C.

The smoke-dried livestock bones, onions of 30 weight parts, cabbages of 30 weight parts, Flammulina velutipes of 10 weight parts, carrots of 10 weight parts, Chinese mushrooms of 5 weight parts, celeries of 3 weight parts, pericarp of grapes (dried) of 2 weight parts and sea tangle of 2 weight parts were put in a pan containing water of 400 weight parts as the extraction material, and the water was heated. The extraction material was immersed in hot water of 90° C. for 4 hours. After the extraction material was heated, the extraction material was filtered, and the extraction residue such as livestock bones was separated and removed to obtain the extraction solvent (extraction solvent generating step).

As the vegetable absorbent material peeled and cut sweet potatoes of 50 weight parts, rice brans (degreased) of 50 weight parts and tea leaves (dried after decocting green tea) of 3 weight parts were added into the obtained extraction solvent, and thoroughly boiled. The extraction solvent was absorbed to the vegetable absorbent material (extraction solvent absorption step).

The vegetable absorbent material absorbing the extraction solvent was dried at 80 to 90° C. in a hot air dryer for 12 hours to obtain a dried matter. This dried matter was pulverized and powdered by a pulverizer (drying and powdering step) to obtain a nutritional supplement of Example 3.

### COMPARATIVE EXAMPLE 1

Cow ribs of 100 weight parts as the livestock bones cut to 2 cm in width were put in a pan containing water of 500 weight parts, and the water was heated. The livestock bones were immersed in hot water of 90° C. for 3 hours. After lixivium was fully scooped, the hot water was filtered, and the extraction residue of the livestock bones was separated and removed to obtain an extraction solvent. The obtained extraction solvent was spray dried to obtain a nutritional supplement of Comparative Example 1.

### COMPARATIVE EXAMPLE 2

A nutritional supplement of Comparative Example 2 was obtained in the same manner as in Example 2 except that the bony parts of sea bass of 100 weight parts were used as the bony parts of fish, and that the bony parts were not smoke-dried.

### COMPARATIVE EXAMPLE 3

A nutritional supplement of Comparative Example 3 was obtained in the same manner as in Example 3 except that the chicken bones of 100 weight parts as the livestock bones were used, and that the chicken bones were not smoke-dried.

(Evaluation of Nutritional Supplement)

The nutritional supplements of Examples 1 to 3 and Comparative Examples 1 to 3 were eaten by ten men and women as samplers. Comparative evaluations were performed for four items of “sticky difficulty of nutritional supplement”, “fishy smell and animal smell”, “deliciousness of fish and meat”, “flavor” and “deliciousness of vegetables.” Five-step sensory evaluations of ++ (very good), + (good), ± (average), − (poor) and −− (very poor) were performed. Specifically, the evaluations are as follows.

“Sticky difficulty of nutritional supplement”: very good . . . Powders left on a plate are hardly caked, and are hardly sticky; good . . . Though the powders left on the plate are slightly caked, the caking is not conspicuous; average . . . The powders left on the plate are slightly caked; poor . . . The powders left on the plate are caked, and are slightly sticky; and very poor . . . The powders left on the plate are sticky.

“Fishy smell and animal smell”: very good . . . fishy smell and animal smell are not sensed at all; good . . . The fishy smell or the like is not sensed; average . . . Though the fishy smell or the like is slightly sensed, the fishy smell is not conspicuous; poor . . . The fishy smell or the like is sensed; and very poor . . . The fishy smell or the like is remarkably sensed.

“Deliciousness of fish and meat”: very good . . . The deliciousness is remarkably sensed; good . . . The deliciousness is sensed; average . . . The deliciousness is slightly sensed; poor . . . The deliciousness is hardly sensed; and very poor . . . The deliciousness is not sensed at all.

“Deliciousness of vegetables or the like”: very good . . . The deliciousness of grains, tuberous roots and vegetables or the like is remarkably sensed; good . . . The deliciousness is sensed; average . . . The deliciousness is slightly sensed; poor . . . The deliciousness is hardly sensed; and very poor . . . The deliciousness is not sensed at all.

Table 1 shows the average of ten men and women performing sensory evaluations using the above standard.

TABLE 1

| | | Blood Smell | Deliciousness | Deliciousness |
|---|---|---|---|---|
| | Stickiness | of Meat, etc | of Meat, etc | of Vegetables |
| Example 1 | ++ | ++ | + | + |
| Example 2 | ++ | ++ | + | + |
| Example 3 | ++ | ++ | ++ | ++ |
| Comparative | −− | −− | ± | −− |
| Example 1 | | | | |
| Comparative | ++ | − | + | ± |
| Example 2 | | | | |
| Comparative | ++ | − | + | + |
| Example 3 | | | | |

As shown in Table 1 , the following evaluations of the nutritional supplements of Examples 1 to 3 were obtained. The powders were hardly caked, and were hardly sticky. Also, the fishy smell and animal smell were not sensed at all. The deliciousness of the meat, fish and vegetables or the like was fully sensed. High evaluations that the enriched flavor was sensed when eating were obtained from the samplers.

On the other hand, some samplers sensed the fishy smell and animal smell and complained of the nutritional supplements of Comparative Examples 1 to 3. Particularly, many samplers evaluated that the powders left on the plate are sticky and have poor handleability in the nutritional supplement of Comparative Example 1.

As described above, it was obvious that this Example hardly generated a hygroscopic phenomenon, was hardly caked, had excellent handleability, could enhance the deliciousness without sensing a fishy smell and an animal smell, and could impart an enriched flavor. Since the Example can be composed by various foods, it is obvious that the Example excelled also in nutritional balance.

In Example 1, one obtained by putting any one kind of salts, inosinic acid salts, glutamic acid salts and capsicum or the like into hot water, and extracting the livestock bones was also produced. Many samplers evaluated that the deliciousness of the nutritional supplement manufactured by using these extraction solvents was increased.

The present invention relates to the method for manufacturing the nutritional supplement using the bony parts of fish and livestock bones, the nutritional supplement and the processed grain foods using the same.

The present invention can provide the method for manufacturing the nutritional supplement hardly generating a hygroscopic phenomenon, being hardly caked, having excellent handleability, hardly generating a browning phenomenon, capable of being stored and preserved for a long period, having excellent preservability, enhancing commercial value, capable of enhancing deliciousness, nutritional value, and nutritional balance, capable of imparting an enriched flavor without sensing a fishy smell and an animal smell, and capable of effectively utilizing bony parts of fish and livestock bones which have been mostly disposed as useful food resources. The present invention can also provide the nutritional supplement having excellent deliciousness, nutritional value and nutritional balance, capable of being stored and preserved for a long period, having excellent preservability, excellent in applicability since the vegetable absorbent material is mixed with other food material such as flour, and the nutritional supplement is formed into pellets or the like to be processed into tablets, hardly generating a hygroscopic phenomenon, being hardly caked, having excellent handleability, hardly generating a browning phenomenon, enhancing commercial value, having an enriched flavor without sensing a fishy smell and an animal smell, and capable of effectively utilizing bony parts of fish and livestock bones which have been mostly disposed as useful food resources. The present invention can still further provide the processed grain foods providing nutrients and minerals such as collagen, mucopolysaccharides, amino acids, calcium, iron and zinc or the like, plant proteins, carbohydrates, minerals and vitamins, and having high nutritional value.

What is claimed is:

1. A method for manufacturing a nutritional supplement, comprising:
an extraction solvent generating step of immersing an extraction material containing smoke-dried bony parts of fish and/or livestock bones in hot water, and separating an extraction residue to obtain an extraction solvent;
an extraction solvent absorption step of absorbing the extraction solvent in at least one vegetable absorbent material of grains, tuberous roots, bean curd refuse, tea leaves, brans and pericarp; and
a drying and powdering step of drying and powdering said vegetable absorbent material absorbing said extraction solvent.

2. The method for manufacturing the nutritional supplement according to claim 1, wherein said extraction material contains at least one of vegetables, pericarp and seaweeds.

3. A nutritional supplement containing a vegetable absorbent material containing at least one of dried and powdered grains, bean curd refuse, tea leaves, rice brans and tuberous roots absorbing an extraction solvent of smoke-dried bony parts of fish and/or livestock bones.

4. The nutritional supplement according to claim 3, wherein the extraction solvent of at least one of vegetables, pericarp and seaweeds is absorbed in said vegetable absorbent material.

5. The nutritional supplement according to claim 3 or 4, wherein at least one of health foods, enrichments, fungi, sweeteners and vinegars is mixed in the dried and powdered vegetable absorbent material.

6. Processed grain foods containing the nutritional supplement according to any one of claims 3 to 5.
